(19) United States
(12) Patent Application Publication
(10) Pub. No.: US 2005/0177577 A1
(43) Pub. Date: Aug. 11, 2005

(54) Accessing data on remote storage servers

(75) Inventors: Nadarajah Asokan, Espoo (FI); Tapio Suihko, Espoo (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/769,467

(22) Filed: Jan. 30, 2004

(51) Int. Cl. G06F 7/00

(52) U.S. Cl. 707/100

(57) ABSTRACT

This invention describes a methodology for accessing data on a legacy file server (or a remote storage server) by a communication device (e.g., a mobile device or a mobile phone) using an access gateway, wherein said communication device cannot support the legacy file system protocol. The basic idea of the invention is to provide an access gateway that functions as an application-level protocol translator in a situation when the communication device cannot support the legacy file system protocol for entering the legacy file server.

### FIELD OF THE INVENTION

This invention generally relates to communication systems and more specifically to accessing data on a remote file server by a communication device.

### BACKGROUND OF THE INVENTION

Important data is stored on existing remote storage servers or legacy file servers. The term the “legacy file server” in the context of the present invention is broadly applied to all kinds of remote storage servers including those from previous generations of an obsolete management which preferably can be updated but not destroyed, and to those which are presently current or already updated.

These legacy file servers (or remote storage servers) support protocols like a server message block/common internet file system (SMB/CIFS) or a network file system (NFS) that are widely used in the PC world. Frequently it is desirable to access this data by a user of a communication device (e.g., a mobile device or a mobile phone) and it would be extremely useful if the user can access this data from the communication device seamlessly. Frequently this is not possible because the communication device cannot support the legacy file system protocol for communicating directly with the legacy file server. The solution is to implement the appropriate client software on the communication (mobile) device platform. However, this implementation can be difficult for the following reasons:
Complexity of porting: distributed file systems are typically large pieces of software and porting this is likely to have a significant complexity.
Potential legal and licensing problems: e.g., if the data transfer protocol is proprietary, client implementations may be disallowed by the owner of the protocol, or may be subject to licensing.

Therefore, an alternative simple solution is desired. The major challenge for such a solution is how to allow an access to the legacy file server (such as a SMB/CIFS) from the communication device such as a mobile phone without actually implementing the client protocol on the communication device, but still preserving a proper access control.

### SUMMARY OF THE INVENTION

The object of the present invention is to provide a methodology for accessing data on a legacy file server (or a remote storage server) by a communication device (e.g., a mobile device or a mobile phone) using an access gateway while retaining all the access control checks that are applied when a user accesses the legacy file server directly.

According to a first aspect of the invention, a method for accessing data on a legacy file server by a communication device using an access gateway, comprising the steps of: sending a login request signal containing information identifying the legacy file server and share information needed for collecting said data on the legacy file server to which said accessing is desired, by a data transfer protocol file system of the communication device to the access gateway; determining by the access gateway whether the login request signal has a predetermined format; sending a mount command signal containing said share information by the access gateway to the legacy file server if the login request signal has a predetermined format; and deciding by the legacy file server whether to grant an access to a requested share and sending a success/failure mount signal to the access gateway for initiating said accessing to said data.

According further to the first aspect of the invention, prior to the step of sending the login request signal, the method may further comprise the steps of: sending a starting signal containing an address of the access gateway to a mounter application block of the communication device by a user; and sending a mount request signal containing said share information and user credential information by the mounter application block to the data transfer protocol file system of the communication device. Still further, the user credential information may be a password.

Further according to the first aspect of the invention, after the step of sending the login request signal, the method may further comprise the steps of: sending a request for said user credential information to the data transfer protocol file system by the access gateway; and sending said user credential information by the data transfer protocol file system to the access gateway. Still further, the login request signal and the user credential information may be sent by a data transfer protocol file system of the communication device, the request for the user credential information may be sent to the data transfer protocol file system by a modified data transfer protocol server of the access gateway, and the determination whether the login request signal has a predetermined format may be performed by the modified data transfer protocol server. Yet further, prior to the step of sending the mount command signal, the method may comprise the step of: decoding the login request signal by the modified data transfer protocol server and sending a further mount request signal by said modified data transfer protocol server to a client block of the access gateway. Yet still further, the mount command signal may be sent to a server of the legacy file server by the client block in response to the further mount request signal.

Still further according to the first aspect of the invention, the client block and the server may support a server message block/common internet file system (SMB/CIFS) protocol. Further, the data transfer protocol file system and the modified data transfer protocol server may support a file transfer protocol (FTP) or a WebDAV protocol. Still further, the success/failure mount signal may be sent to the client block by the server and the method may further comprise the step of: determining by the client block whether the mount is granted based on the success/failure mount signal. Yet still further, if the mount is granted, the method may further comprise the steps of: mounting by the client block the share from the legacy file server on a mountpoint of the access gateway; configuring the access gateway to ensure accessibility of said mountpoint only by an authorized communication device; and sending to the communication device by the modified data transfer protocol server a login success mount signal authorising access of the communication device to said data contained in the legacy file server. Still yet further, the method may further comprise the step of: accessing said data on the legacy file server by the communication device using communicating of said communication device with the legacy file server through said mountpoint of said access gateway.

According further to the first aspect of the invention, the communication device may be a mobile device or a mobile phone.

According to a second aspect of the invention, a communication system for accessing data on a legacy file server, comprising: a communication device, responsive to a starting signal from a user and to a success/failure login signal, for providing a login request signal and a mount status signal to the user, wherein said login request signal has a predetermined format and contains information identifying the legacy file server and share information needed for collecting said data on the legacy file server to which said accessing is desired; and an access gateway, responsive to the login request signal and to a success/failure mount signal from said legacy file server, for providing a mount command signal containing said share information to said legacy file server and for providing the success/failure login signal.

According further to the second aspect of the invention, the communication device may comprise: a mounter application block, responsive to the starting signal from the user and to a success/failure response signal, for providing a mount request signal and for providing the mount status signal to the user; and a data transfer protocol file system, responsive to the success/failure response signal, to an application request signal and to the success/failure login signal, for providing the login request signal, the success/failure response signal and a data signal. Further, if the data transfer protocol file system is further responsive to the application request signal and providing the data signal, said communication device may further comprise: application blocks, responsive to a further starting signal after receiving the mount status signal indicating that said mounting is successful, and to the data signal, for providing the application request signal.

Further according to the second aspect of the invention, the access gateway may comprise: a modified data transfer protocol server, responsive to the login request signal and to a further success/failure mount signal, for providing a further mount request signal and the mount command signal; and a client block, responsive to the further mount request signal, for providing the mount command request signal. Further, the communication device may be further providing a data request signal to the access gateway and is responsive to a further data signal; the modified data transfer protocol server may be further responsive to a further data request signal and to a further initial data signal and providing the further data signal; and the client block may be further responsive to an initial data signal from a server of the legacy file server and providing the further initial data signal. Still further, the client block and the server may support a server message block/common internet file system (SMB/CIFS) protocol. Yet still further, the data transfer protocol file system and the modified data transfer protocol server may support a file transfer protocol (FTP) or a WebDAV protocol.

Still further according to the second aspect of the invention, the communication device may be a mobile device or a mobile phone.

According to a third aspect of the invention, a communication device, capable of accessing data on a legacy file server using an access gateway, comprises: a mounter application block, responsive to a starting signal from a user and to a success/failure response signal, for providing a mount request signal and for providing a mount status signal to the user; and a data transfer protocol file system, responsive to a success/failure response signal and to a success/failure login signal, for providing a login request signal and a success/failure response signal, wherein said login request signal has a predetermined format and contains information identifying the legacy file server and share information needed for collecting said data on the legacy file server to which said accessing is desired.

According further to the third aspect of the invention, the data transfer protocol file system may be further responsive to an application request signal and may be providing a data signal, and the communication device may further comprise: application blocks, responsive to a further starting signal after receiving the mount status signal indicating that said mounting is successful, and to the data signal, for providing the application request signal. Further, the data transfer protocol file system may comprise: a data transfer protocol stack block, responsive to the success/failure login signal and, after adapting, to the mount request signal and to the application request signal, for providing a login request signal and, after adapting, the success/failure response signal and the data signal; and a remote storage client (RSC) adaptor, for said adapting for matching transfer formats of all signals communicating between the mounter application block and the data transfer protocol stack block and between the application block and the data transfer protocol stack block.

Further according to the third aspect of the invention, the communication device may be a mobile device or a mobile phone.

Still further according to the third aspect of the invention, the data transfer protocol stack block may support a file transfer protocol (FTP) or a WebDAV protocol

According to a fourth aspect of the invention, a computer program product comprising: a computer readable storage structure embodying computer program code thereon for execution by a computer processor with said computer program code characterized in that it includes instructions for performing the steps of the method of claim 1 indicated as being performed by a communication device alone, by an access gateway alone or by legacy file server alone or by any combination of the communication device, the access gateway and the legacy file server.

### BRIEF DESCRIPTION OF THE DRAWINGS

For a better understanding of the nature and objects of the present invention, reference is made to the following detailed description taken in conjunction with the following drawings, in which:

FIG. 1 is a block diagram representing an example of a communication system for accessing data on a legacy file server by a communication device having an FTP file system, according to the present invention.

FIG. 2 is a flow chart illustrating a performance of a communication system for accessing data on a legacy file server by a communication device having an FTP file system, according to the present invention.

### DISCLOSURE OF THE INVENTION AND BEST MODE FOR CARRYING OUT THE INVENTION

The present invention provides a methodology for accessing data on a legacy file server (or a remote storage server) by a communication device (e.g., a mobile device or a mobile phone) using an access gateway and processing a proper access protocol, wherein said communication device cannot support the legacy file system protocol.

The basic idea of the invention is to provide an access gateway that functions as an application-level protocol translator in a situation when the communication device (e.g., the mobile device or the mobile phone) cannot support the legacy file system protocol for communicating directly with the legacy file server. Then according to the present invention said access is accomplished by:
a) The communication device sends a login request and necessary credentials and other information, such as a “share” (collection of data files) to which an access is requested, and an address of the legacy file server hosting this share, to the access gateway using a standard data transfer protocol, like a file transfer protocol (FTP) or a WebDAV protocol.
b) A modified data transfer protocol server (supporting said standard data transfer protocol) of the access gateway extracts said login request and necessary credential information and constructs a mount request including legacy file share information, which include said credential for accessing the share in the legacy file server, and submits said mount request in the legacy protocol format such as, for example, standard server message block/common internet file system (SMB/CIFS) protocol to the legacy file server. Thus at this point, the access gateway does not perform any access control as it normally does in the standard data transfer protocol (e.g., the FTP). Instead, it defers the access control to be done by the legacy file server. This avoids a need to copy access control information from the legacy file server to the access gateway and maintain said information on the access gateway.
c) The requested share is mounted on the access gateway if the legacy file server accepts the mount request, and then the communication device is authorized to access said share through a mountpoint at a file system of the access gateway.

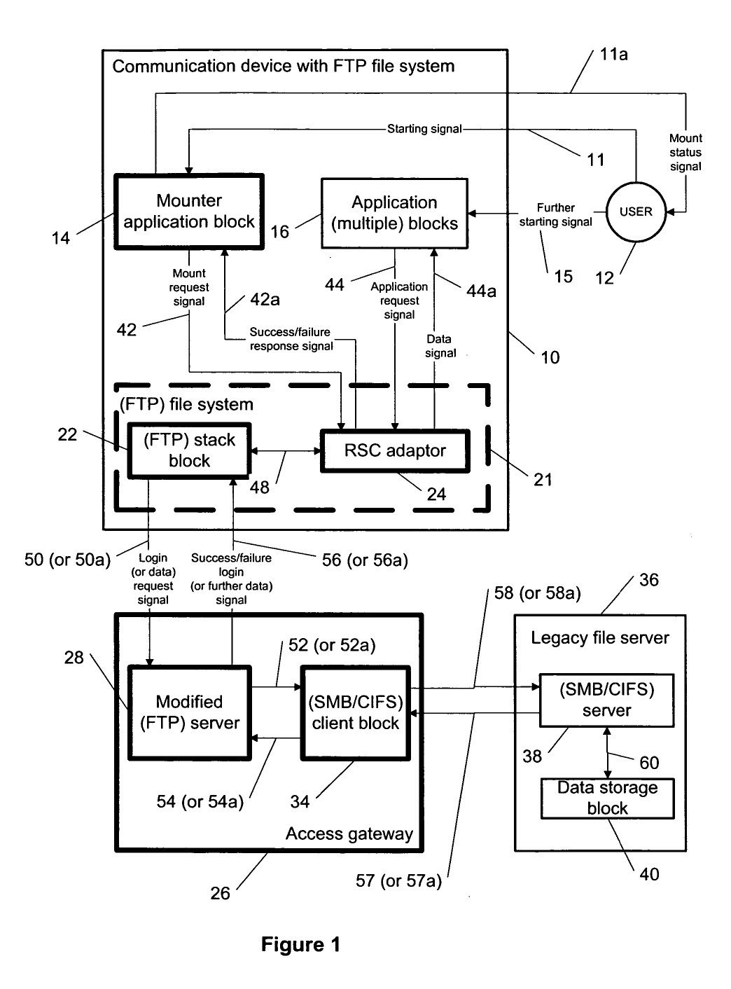

FIG. 1 shows a block diagram representing one example among many others of a communication system for accessing data on a legacy file server 36 by a communication device 10, according to the present invention.

The communication device 10, for example, can be a mobile device or a mobile phone. In the example of FIG. 1 the FTP is used as a data transfer protocol between the communication device 10 and an access gateway 26, but it can be any standard data transfer protocol, for example, the WebDAV. The communication device 10 contains a mounter application block 14, an FTP file system 21 (in general case this block can be called “a data transfer protocol file system”) and application blocks (multiple blocks) 16. In the example of FIG. 1 the FTP file system 21 comprises an FTP stack block 22 (in general case this block can be called “a data transfer protocol stack block”) and a remote storage client (RSC) adaptor 24. The block 24 is an adapting block for matching transfer formats of all signals communicating between the mounter application block 14 and the data transfer protocol stack block 22 and between the application block 16 and the data transfer protocol stack block 22. Signal 48 in FIG. 1 identifies such an adaptation procedure.

The mounter application block 14, in response to a starting signal 11 containing an address or any other identity of the access gateway 26 from a user 12, provides a mount request signal 42 to the RSC adaptor 24 and subsequently (after adapting) to the FTP stack block 22. Said mount request signal 42 can contain the address (name) of an access gateway, a username, a domain, a share to mount, optionally a directory within the share and a host to mount it from, and user credential information (e.g., password).

In response to the mount request signal 42 the FTP stack block 22 encodes a login request signal (typically containing the username, domain, host, share information, directory) and sends said login request signal 50 to a modified FTP server 28 (in general case this block can be called “a modified data transfer protocol server”) of an access gateway 26 (its address is contained in the signal 42).

In response to the login request signal 50 the modified FTP server 28 sends a request for the user credential information to the FTP stack block 22. Following said request, the FTP stack block 22 sends the user credential information to the modified FTP server 28. Then the modified FTP server 28 evaluates the received information: whether the login request signal 50 has a predetermined format. If the evaluation is positive and all conditions are met, the modified FTP server 28 decodes the login request signal 50 and constructs a further mount request signal 52 which includes legacy file share information requested to be mounted on the access gateway 26 and submits said further mount request signal 52 (after adapting, wherein the adapting block is not shown in FIG. 1) typically containing a pathname of a mountpoint on the access gateway 26, username, password, domain, host, share, etc. to a server message block/common internet file system (SMB/CIFS) client block 34 (in general case this block can be called just “a client block”) of the access gateway 26. In the block 34 of FIG. 1, an SMB/CIFS protocol is used but in general, any appropriate protocol can be used as well using some other distributed file systems (DFSs), like e,g., a network file system (NFS).

Typically, the mountpoint is a special node in a filesystem. It is a root directory of a file hierarchy contained within a distinct storage space. This storage space can consist, e.g., of a whole disk drive, or a partition of the disk drive, or a remotely accessible file store such as “share” as defined here. In unix-like systems, a mountpoint looks like any other directory, and mounting a store at a specific mountpoint establishes the store's location in the directory hierarchy. This location is implied by the pathname of the mountpoint (e.g., “/mnt/samba_share/”).

In response to the further mount request signal 52, the SMB/CIFS client block 34 identifies an SMB/CIFS server 38 (in general case this block can be called just “a server”) of a legacy file server 36 and sends a mount command signal 58 (username, password, domain, share) to said SMB/CIFS server 38. Again, in the block 38 of FIG. 1, an SMB/CIFS protocol is used but in general, any appropriate protocol (the same as in the block 34) can be used as well.

In response to the mount command signal 58, the SMB/CIFS server 38 verifies the submitted information, decides, based on said verification, if the access to the requested legacy file share is granted and sends a success/failure mount signal 57 to the SMB/CIFS client block 34. Furthermore, if said access to the requested legacy file share is granted, the success mount signal 57 can contain (optionally) said legacy file share information retrieved from a data storage block 40 of the legacy file server 36 by the SMB/CIFS server 38, and the SMB/CIFS client block 34 mounts said legacy file share on a mountpoint (not shown in FIG. 1) at a file system of the access gateway 26. The further success/failure mount signal 54 is provided (after adapting, wherein the adapting block is not shown in FIG. 1) to the modified FTP server 28, which, in response only to the success mount signal 54 (if said mounting is successful), configures the access gateway 26 to ensure accessibility to data stored on the legacy file server 36 only by an authorized user.

The modified FTP server 28 reports to the user 11 about success/failure of the login authorizing access through a chain of signals shown in FIG. 1: a success/failure login signal 56, followed by a success/failure response signal 42a and finally followed by a mount status signal 11a. In response to the success response signal 42a (if said mounting is successful) the mounter application block 14 mounts the remote filesystem reachable via the FTP connection as a drive (or on another mountpoint) on the communication device 10.

After the mounting process is completed successfully, the access to the desired application data by the authorized user 12 is performed by separate file operation requests restricted to a sandbox in the access gateway (26) so that the FTP session of the communication device 10 can only access said mounted share that it was authorized to access (e.g., using the Unix chroot( ) system call to set the mountpoint as the root directory of the FTP server process that is serving the session). The user 12 sends a further starting signal 15 to at least one of the application blocks 16 (for a specific application) of the communication device 10. Then at least one of the application blocks 16 sends an application request signal 44 to perform a file operation on the mounted (as described above) share through the mountpoint of the access gateway 26, through a chain of signals: a data request signal 50a, further data request signal 52a and a data command signal 58a. Said one of the application blocks 16 receives back the requested data for the specific application from the legacy file server 36 through another chain of signals: an initial data signal 57a, a further initial data signal 54a, a further data signal 56a and a data signal 44a. It is noted that the actual meaning of the signal 52 is that, after receiving the data request signal 50a, the modified FTP server 28 attempts to read the requested data from said mountpoint of the access gateway 26, which triggers the SMB/CIFS client block 34 to send the data command signal 58a to the SMB/CIFS server 38 of the legacy file server 36 using, e.g., a SMB/CIFS protocol, thus facilitating translating from the FTP protocol to the CIFS/SMB protocol. The requested data is sent to the user 11 by the legacy file server 36 through the chain of signals as described above, wherein the responses are translated from the CIFS/SMB protocol back to the FTP protocol. The end result is that the requested data is taken from the legacy file server 36 and sent back to the communication device 10.

There are many variations of the example shown in FIG. 1. E.g. in the example of FIG. 1 the access control is done by passing the user's credential (username/password) from the communication device 10 to the access gateway 26. In an alternative scenario the access control can be implemented by delegating of an authorization from the communication device 10 to the access gateway 26. The file operation signaling given in the above example only involves fetching of the data from the mounted share. However, filesystem application programming interfaces (APIs) and file transfer protocols allow various operations to be performed on the files on the mounted share (e.g., creating files and directories and removing and renaming them).

Furthermore, the access gateway 26 can have a complete access to the user's data. Therefore it is desirable: (a) for the communication device 10 to authenticate the access gateway 26, and (b) to ensure that the device-gateway communication is confidentiality protected. For example, the access gateway 26 can be behind a corporate firewall, and the device-gateway communication can be secured by a virtual private network (VPN) connection. This is likely to be the case for accessing corporate data servers.

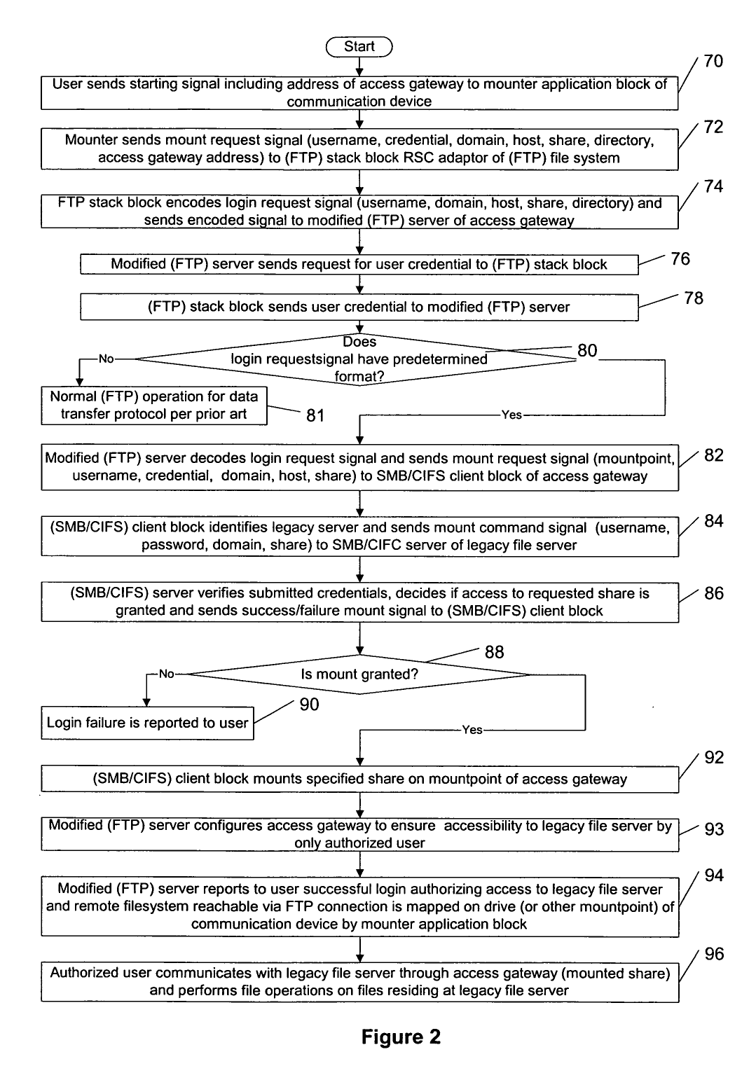

FIG. 2 is a flow chart illustrating a performance of a communication system for accessing data on a legacy file server 36 by a communication device 10, according to the present invention. The flow chart of FIG. 2 only represents one possible scenario among many others. In a method according to the present invention, in a first step 70, the user 12 sends the starting signal 11 including address of the access gateway 26 to the mounter application block 14 of the communication device 10. In a next step 72, the mounter application block 14 provides the mount request signal 42 (containing the username, credential, domain, host, share, directory, access gateway address) to the RSC adaptor 24 and subsequently (after adapting by the block 24) to the FTP stack block 22. In a next step 74, the FTP stack block 22 encodes the login request signal (containing the username, domain, host, share information, directory) and sends said login request signal 50 to the modified FTP server 28 of the access gateway 26.

In a next step 76, the modified FTP server 28 sends the request for the user credential information to the FTP stack block 22. In a next step 78, the FTP stack block 22 sends the user credential information to the modified FTP server 28 in response to said request. In a next step 80, it is ascertained by the modified FTP server 28 whether the login request signal 50 has a predetermined format. As long as that is not the case, in a step 81, a normal FTP operation per the prior art can follow. However, if it is ascertained that the login request signal 50 has a predetermined format, in a next step 82, the modified FTP server 28 decodes the login request signal 50 and constructs the mount request signal 52 which includes the legacy file share information (said share information is requested to be mounted on the access gateway 26) and submits said mount request signal 52 typically containing the pathname of the mountpoint, username, password, domain, host, share, etc. to a the SMB/CIFS client block 34 of the access gateway 26.

In a next step 84, the SMB/CIFS client block 34 identifies the SMB/CIFS server 38 of a legacy file server 36 and sends a mount command signal 58 (username, password, domain, share) to said SMB/CIFC server 38.

In a next step 86, the SMB/CIFS server 38 verifies the submitted information, decides if the access to the requested legacy file share is granted, retrieves said share from a data storage block 40 of the legacy file server 36 if the access is granted, and sends success/failure mount signal 57 to the SMB/CEFS client block 34.

In a next step 88, it is ascertained by the SMB/CIFS client block 34 whether the mount is granted. As long as that is not the case, in a step 90, the login failure is reported to the user 11 (through the chain of signals: the further failure mount signal 54, the failure login signal 56, the failure response signal 42a and the mount status signal 11a). However, if it is ascertained that the mount is granted, in a next step 92, the SMB/CIFS client block 34 mounts the share (optionally) contained in the success mount signal 57 on the mountpoint of the access gateway 26. In a next step 93, the modified FTP server 28 configures the access gateway 26 to ensure accessibility to the legacy file server 36 and to the share mounted on the access gateway 26 (and therefore to the legacy file server 36) only by the authorized user. In a next step 94, the modified FTP server reports to the user 11 about success of the login authorizing access through a chain of the signals: the success login signal 56, the success response signal 42a and the mount status signal 11a and, in response to the signal 42a, the mounter application block 14 mounts the remote filesystem reachable via the FTP connection as a drive (or on another mountpoint) on the communication device 10.

In a next step 96, after successful mount of the share on the mountpoint of the access gateway 26, the authorized user 11 communicates with the legacy file server 36 through the access gateway 26 and extracts application specific data as described above.

As explained above, the invention provides both a method and corresponding equipment consisting of various modules providing the functionality for performing the steps of the method. The modules may be implemented as hardware, or may be implemented as software or firmware for execution by a processor. In particular, in the case of firmware or software, the invention can be provided as a computer program product including a computer readable storage structure embodying computer program code, i.e. the software or firmware thereon for execution by a computer processor (e.g., provided with the terminal 10, and/or the access gateway 26 and/or the legacy file server 36).

1. A method for accessing data on a legacy file server by a communication device using an access gateway, comprising the steps of:
sending a login request signal containing information identifying the legacy file server and share information needed for collecting said data on the legacy file server to which said accessing is desired, by a data transfer protocol file system of the communication device to the access gateway;
determining by the access gateway whether the login request signal has a predetermined format;
sending a mount command signal containing said share information by the access gateway to the legacy file server if the login request signal has a predetermined format; and
deciding by the legacy file server whether to grant an access to a requested share and sending a success/failure mount signal to the access gateway for initiating said accessing to said data.

2. The method of claim 1, wherein prior to the step of sending the login request signal, the method further comprises the steps of:
sending a starting signal containing an address of the access gateway to a mounter application block of the communication device by a user; and
sending a mount request signal containing said share information and user credential information by the mounter application block to the data transfer protocol file system of the communication device.

3. The method of claim 2, wherein the user credential information is a password.

4. The method of claim 2, wherein after the step of sending the login request signal, the method further comprises the steps of:
sending a request for said user credential information to the data transfer protocol file system by the access gateway; and
sending said user credential information by the data transfer protocol file system to the access gateway.

5. The method of claim 4, wherein the login request signal and the user credential information are sent by a data transfer protocol file system of the communication device, wherein the request for the user credential information is sent to the data transfer protocol file system by a modified data transfer protocol server of the access gateway, and wherein the determination whether the login request signal has a predetermined format is performed by the modified data transfer protocol server.

6. The method of claim 5, wherein prior to the step of sending the mount command signal, the method comprises the step of:
decoding the login request signal by the modified data transfer protocol server and sending a further mount request signal by said modified data transfer protocol server to a client block of the access gateway.

7. The method of claim 6, wherein the mount command signal is sent to a server of the legacy file server by the client block in response to the further mount request signal.

8. The method of claim 7, wherein the client block and the server support a server message block/common internet file system (SMB/CIFS) protocol.

9. The method of claim 7, wherein the data transfer protocol file system and the modified data transfer protocol server support a file transfer protocol (FTP) or a WebDAV protocol.

10. The method of claim 7, wherein the success/failure mount signal is sent to the client block by the server, the method further comprises the step of:
determining by the client block whether the mount is granted based on the success/failure mount signal.

11. The method of claim 10, wherein the mount is granted, the method further comprises the steps of:
mounting by the client block the share from the legacy file server on a mountpoint of the access gateway;
configuring the access gateway to ensure accessibility of said mountpoint only by an authorized communication device; and
sending to the communication device by the modified data transfer protocol server a login success mount signal authorising access of the communication device to said data contained in the legacy file server.

12. The method of claim 11, further comprising the step of:
accessing said data on the legacy file server by the communication device using communicating of said communication device with the legacy file server through said mountpoint of said access gateway.

13. The method of claim 1, wherein the communication device is a mobile device or a mobile phone.

14. A communication system for accessing data on a legacy file server, comprising:
a communication device, responsive to a starting signal from a user and to a success/failure login signal, for providing a login request signal and a mount status signal to the user, wherein said login request signal has a predetermined format and contains information identifying the legacy file server and share information needed for collecting said data on the legacy file server to which said accessing is desired; and
an access gateway, responsive to the login request signal and to a success/failure mount signal from said legacy file server, for providing a mount command signal containing said share information to said legacy file server and for providing the success/failure login signal.

15. The communication system of claim 14, wherein the communication device comprises:
a mounter application block, responsive to the starting signal from the user and to a success/failure response signal, for providing a mount request signal and for providing the mount status signal to the user; and
a data transfer protocol file system, responsive to the success/failure response signal, to an application request signal and to the success/failure login signal, for providing the login request signal, the success/failure response signal and a data signal.

16. The communication system of claim 15, wherein the data transfer protocol file system is further responsive to an application request signal and providing a data signal, said communication device further comprises:
application blocks, responsive to the further starting signal after receiving the mount status signal indicating that said mounting is successful, and to the data signal, for providing the application request signal.

17. The communication system of claim 14, wherein, the access gateway comprises:
a modified data transfer protocol server, responsive to the login request signal and to a further success/failure mount signal, for providing a further mount request signal and the mount command signal; and
a client block, responsive to the further mount request signal, for providing the mount command request signal.

18. The communication system of claim 17, wherein
the communication device is further providing a data request signal to the access gateway and is responsive to a further data signal;
the modified data transfer protocol server is further responsive to a further data request signal and to a further initial data signal and providing the further data signal; and
the client block is further responsive to an initial data signal from a server of the legacy file server and providing the further initial data signal.

19. The communication system of claim 17, wherein the client block and the server support a server message block/common internet file system (SMB/CIFS) protocol.

20. The communication system of claim 17, wherein the data transfer protocol file system and the modified data transfer protocol server support a file transfer protocol (FTP) or a WebDAV protocol.

21. The communication system of claim 14, wherein the communication device is a mobile device or a mobile phone.

22. A communication device, capable of accessing data on a legacy file server using an access gateway, comprising:
a mounter application block, responsive to a starting signal from a user and to a success/failure response signal, for providing a mount request signal and for providing a mount status signal to the user; and
a data transfer protocol file system, responsive to a success/failure response signal and to a success/failure login signal, for providing a login request signal and a success/failure response signal, wherein said login request signal has a predetermined format and contains information identifying the legacy file server and share information needed for collecting said data on the legacy file server to which said accessing is desired.

23. The communication device of claim 22, wherein the data transfer protocol file system is further responsive to an application request signal and providing a data signal, said communication device further comprises:
application blocks, responsive to a further starting signal after receiving the mount status signal indicating that said mounting is successful, and to the data signal, for providing the application request signal.

24. The communication device of claim 23, wherein the data transfer protocol file system comprises:
a data transfer protocol stack block, responsible to the success/failure login signal and, after adapting, to the mount request signal and to the application request signal, for providing a login request signal and, after adapting, the success/failure response signal and the data signal; and
a remote storage client (RSC) adaptor, for said adapting for matching transfer formats of all signals communicating between the mounter application block and the data transfer protocol stack block and between the application block and the data transfer protocol stack block.

25. The communication device of claim 22, wherein the communication device is a mobile device or a mobile phone.

26. The communication device of claim 22, wherein the data transfer protocol stack block supports a file transfer protocol (FTP) or a WebDAV protocol.

27. A computer program product comprising: a computer readable storage structure embodying computer program code thereon for execution by a computer processor with said computer program code characterized in that it includes instructions for performing the steps of the method of claim 1 indicated as being performed by a communication device alone, by an access gateway alone or by legacy file server alone or by any combination of the communication device, the access gateway and the legacy file server.
